(19) United States
(12) Patent Application Publication
(10) Pub. No.: US 2004/0085194 A1
(43) Pub. Date: May 6, 2004

(54) Portable traffic delineator, dismountable traffic cone

(76) Inventor: Glen Cleland, Queensland (AU)

Correspondence Address: Abelman Frayner & Schwab, 150 East 42nd Street, New York, NY, 10017-5612, US

(21) Appl. No.: 10/362,796

(22) PCT Filed: Aug. 23, 2001
(86) PCT No.: PCT/AU01/01045

(30) Foreign Application Priority Data
Aug. 23, 2000 (AU) 5358200
Apr. 18, 2001 (AU) 3873901

(51) Int. Cl. H05B 41/00

(52) U.S. Cl. 340/332

(57) ABSTRACT

A portable traffic delineator (11), which incudes a first substantially triangular panel (13), a second substantially triangular panel (14), which in use is also upstanding, each panel having a base defined by an edge of the triangle and an upper section defined by a corner of the triangle, the first panel (13) having a slot extending from the base and the second panel (14) having a slot extending from the upper section.

The present invention relates to a portable traffic delineator and in particular relates to a delineator of the traffic cone type.

Traffic delineators in the form of cones are well known and are often referred to as “witch's hats”. Conventional delineators are molded from a plastics material and have a base integral with a conical top. The upper cone is hollow to enable the cones to be stacked for transport and storage. Traffic delineators have a wide range of uses and are typically used to direct traffic around obstacles such as road works or to reroute traffic during public events such as processions and the like. It will be understood that in the present specification and claims the term traffic includes pedestrian and vehicular traffic.

In recent years, the threat of terrorist attack has become of major concern to law enforcement agencies and security personal world wide. Of particular, concern is the risk of acts of terrorism occurring during public events. As mentioned above, traffic cones are widely used to reroute traffic and to guide pedestrians during such events. The cones have a hollow interior (necessary for stacking, transport and storage) which provides a ready place to house an explosive device. A further difficulty with the conventional cones is that, due to their size, it is generally not practicable to store a cone, or a number of cones in a small area such as the boot of a police or security vehicle.

It is therefore an object of the invention to provide a traffic delineator which may at least partially overcome the above disadvantages or provide the public with a useful choice.

According to a first broad form of the invention there is provided a portable traffic delineator, the delineator having a first panel which in use is upstanding and a second panel, the second panel having a slot for receiving a portion of the first panel such that the first panel can be engaged by the second panel and held in said upstanding position.

The delineator may be made from any suitable material and is typically formed from a thermoplastics material, such as a polyolefin. A particularly preferred material is polyethylene. The panel may be molded from the thermoplastics material by conventional techniques well known to those skilled in the art. The delineator may be of any suitable size. Typically, the delineator may have a height of between about 300 mm to about 1 m.

The first panel may be any suitable shape. Typically the panel is substantially triangular whereby one side of the triangle forms a base portion of the panel and the opposing corner, the upper section. The panel may have a substantially uniform width. However, it is preferred that the panel is wider at the base and tapers towards the upper section. This adds further weight to the base of the panel which assists in stabilizing the delineator when subjected to a sideways force.

The second panel has a slot for receiving a portion of the first panel. The second panel may comprise a substantially flat base portion which in use lies flat on the ground. The base may be any suitable shape and is typically circular or square. In this embodiment, the base has a slot for receiving the base of the first panel. Generally the relative dimensions of the slot and base are such that there is a friction fit between the base and second panel.

In another form of the invention, the second panel may be a further upstanding panel. In this case, the second panel may have a slot extending upwards from the base or downwards from the upper section of the panel and the first member has a slot extending from the other of the base or upper part. The respective slots typically have a width corresponding to the thickness of the other panel such that a respective slot can snugly receive a corresponding part of the other panel.

In order to construct the delineator of this embodiment the panel having the slot extending from the base is placed over the panel having the slot extending downwards from the upper part. Typically the panels, when joined, are at right angles to each other. The delineator constructed in this manner is typically self supporting. Typically, this delineator further includes a base member. The base member is typically planar and may be of any suitable shape. The base member is typically provided with slots to receive the respective bases of the first and second panels.

In either embodiment of the invention, the panels may be provided with means of securing the respective panels together. Typical securing means includes a projection or recess on one panel which can engage a corresponding recess or projection on the other panel. In this way, the delineator may be lifted and moved without disassembly.

By way of Example only, the present invention will now be described with reference to the accompanying figures in which:

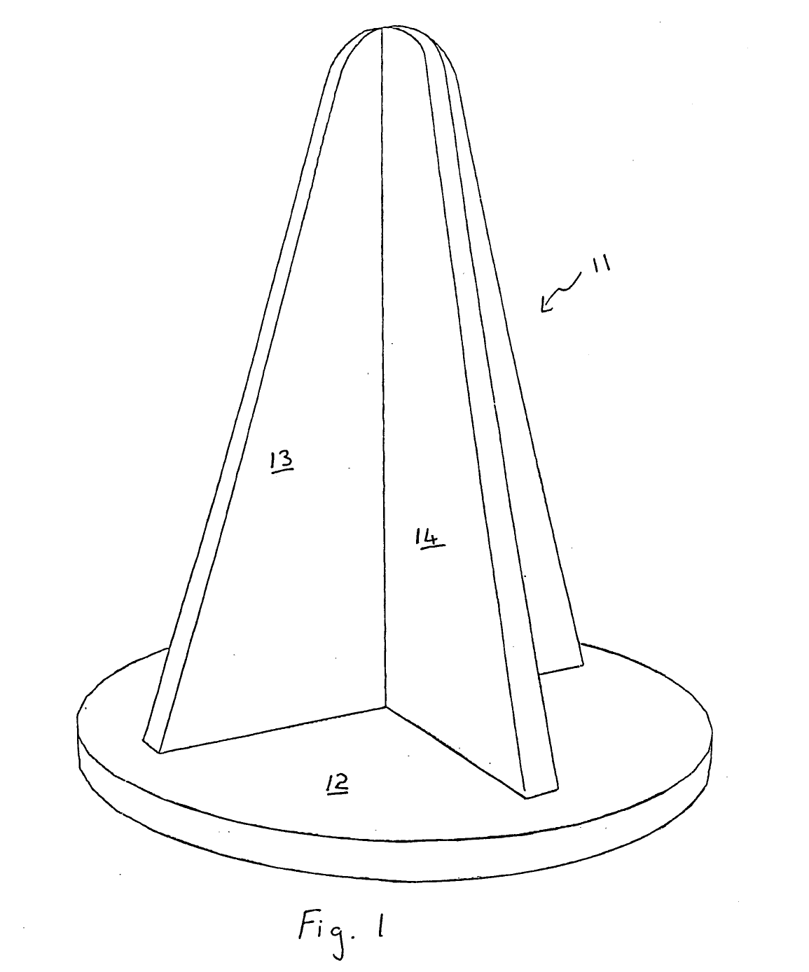

FIG. 1 is a perspective view of a preferred delineator of the present invention;

FIG. 2 is a perspective view of the delineator of FIG. 1 without a base member;

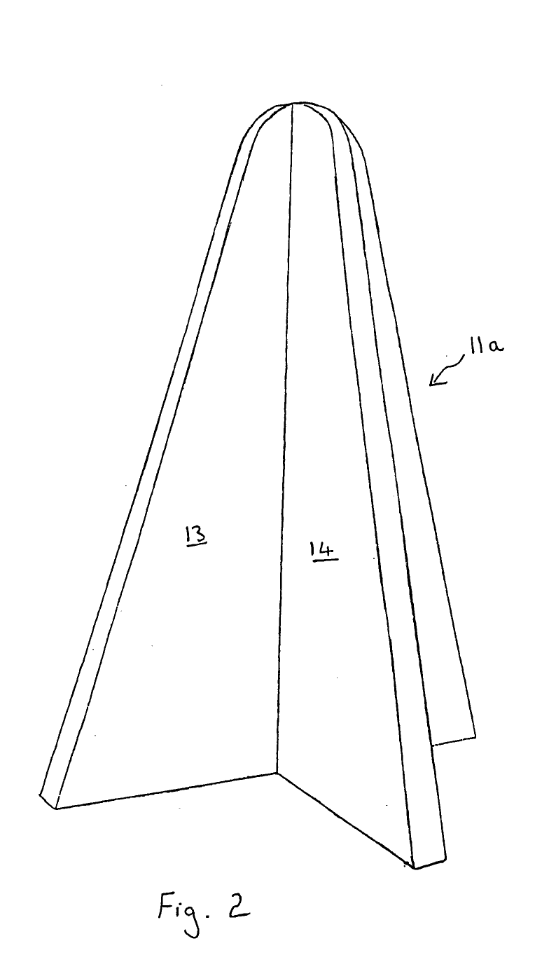

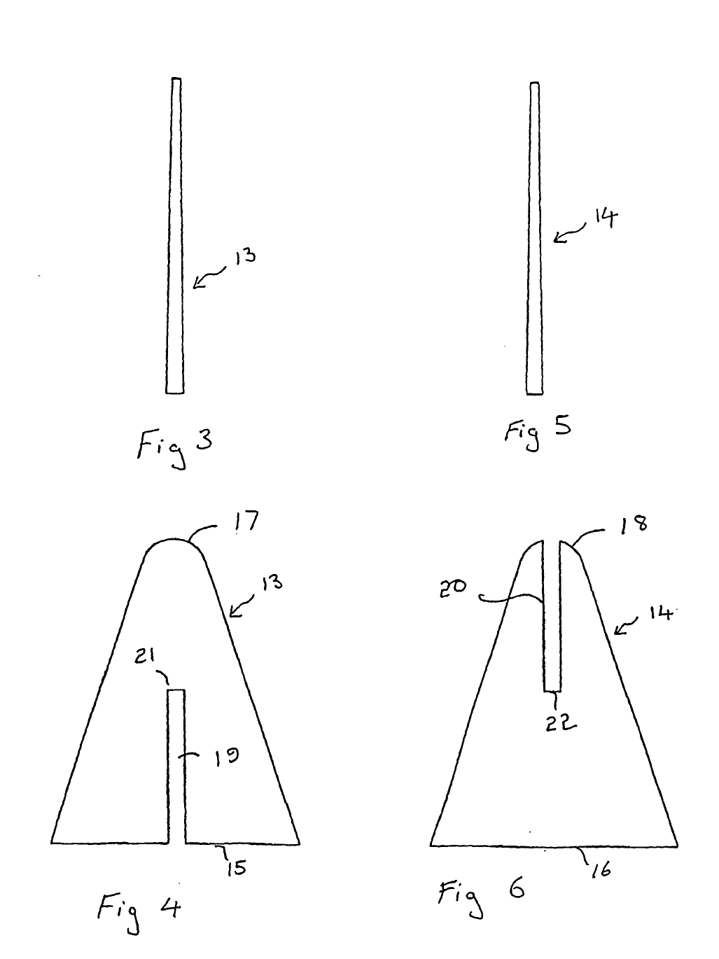

FIG. 3 is a side view of a preferred first panel for use in the construction of a preferred delineator of the present invention;

FIG. 4 is a front view of the panel of FIG. 3;

FIG. 5 is a side view of a preferred second panel for use with the panel of FIG. 3 in the construction of a preferred delineator of the present invention;

FIG. 6 is a front view of the panel of FIG. 5;

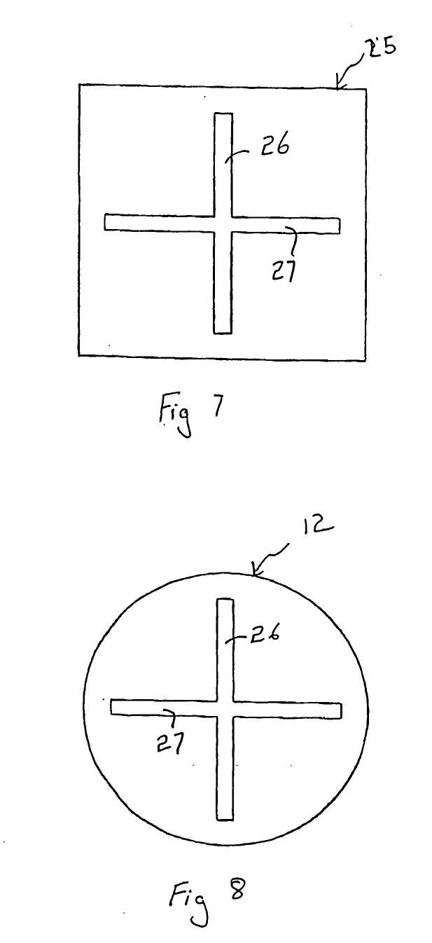

FIG. 7 is a plane view of a preferred base panel which can form part of a preferred delineator of the present invention and

FIG. 8 is a plan view of a further preferred base panel which can form part of a preferred delineator of the present invention.

FIG. 1 illustrates a preferred portable traffic delineator 11 of the present invention. The delineator 11 has a circular base panel 12 and two upstanding panels 13, 14.

The upstanding panels 13, 14 are substantially triangular in shape which can be seen more clearly in FIGS. 3 and 4 and FIGS. 5 and 6. Each panel 13, 14 has a flat base 15, 16 and a rounded apex 17, 18. Each panel is tapered from the base to the apex as shown in FIGS. 3 and 5. By having the panels tapered, more weight is distributed towards the base. This improves the stability of the delineator.

Panel 13 has a slot extending vertically from the base 15. Panel 14 has a slot 20 extending downwardly from the apex 18. Panel 13, when orientated such that the base 15 is at right angles to the base 16 of panel 14 can slide over panel 14 until the closed end 21 of slot 19 meets the closed end 22 of slot 20. The width of the slots corresponds to the width of the respective panels. In this way, the panels fit snugly within the slots. The respective panels are provided with small indents and lugs (not illustrated) molded therein for securing the panels together.

When the panels are joined together, a delineator as illustrated in FIG. 2 is formed. In some applications this delineator may be suitable. However, in use, delineators are often knocked sideways by the traffic they are guiding and may also be subject to being blown by gusts of wind. In order to improve the stability of the delineator of FIG. 2, the base panel 12 is provided. A plan view of the base panel is shown in FIG. 8. An alternative base panel 25 which is square is shown in FIG. 7. Each base panel 12, 25 has a pair of intersecting slots 26, 27. These slots are sized to snugly receive the base 15, 16 of the respective panels 13, 14. Again lugs and notches (not illustrated) may be provided to further secure the panel 13, 14 to the base 12, 25. The lugs and notches also assist in keeping the components together when the delineator is lifted and moved.

The delineator as shown in FIG. 1 is typically constructed by first joining together panels 13 14. The base 12 is then slid over the connected panels.

The panels 13, 14 may be further provided with hook members, projections or other means upon which signalling devices such as tape, lanterns and the like may be mounted or connected. The panels 13, 14 may also be provided with areas of contrasting colour and/or reflective material. This may assist in applications where greater visibility is desired. Also, the panels may be of different colours. such that delineators of different colour combinations may be formed. This may be desirable where different colour combinations can be used to signify different routes or for example blue and white delineators may be used to signify that an area has been cordoned off by the police.

The delineators of the invention may be disassembled and packed in a flat manner. This offers a considerable space saving over traditional conical delineators. This reduction in space can minimize storage and transport costs. It also allows the delineator to be easily carried in the boot of a security or police vehicle.

Another important feature of the delineator of the present invention is that it cannot be used to hide an explosive device.

It will be appreciated that the various changes and modifications may be made to the delineator as described and claimed herein without departing from the sprit and scope of the invention.

The claims defining the invention are as follows:

1. A portable traffic delineator, which includes a first substantially triangular panel, a second substantially triangular panel, each panel having a base defined by an edge of the triangle and an upper section defined by a corner of the triangle, the first panel having a slot extending from the base and the second panel having a slot extending from the upper section such that the two panels can engage and support each other in an upstanding position.

2. The delineator of claim 1 wherein when the two panels are upstanding, the delineator has a height of between about 300 mm to about 1 m

3. The delineator of claim 1 or claim 2, wherein one or both of said panels taper in width from the base to the upper section.

4. The delineator of any one of claims 1 to 3, which includes securing means for securing the panels together.

5. The delineator of claim 4, wherein the securing means includes a projection or recess on one panel which can engage a complimentary recess or projection or the other panel.

6. The delineator of any one of claims 1 to 5 wherein one or both said panels include mounting means for mounting a signalling device.

7. The delineator of any one of claims 1 to 6 wherein one or both panels have areas of contrasting colour.

8. The delineator of any one of claims 1 to 7 which further includes a base member, the base member having first and second slots for receiving the bases of the first and second panels respectively.

9. The delineator of claim 8, wherein there is a friction fit between the base member and panels.

10. A traffic delineator substantially as hereinbefore described with reference to the figures.
